(19) United States
(12) Patent Application Publication
(10) Pub. No.: US 2013/0044488 A1
(43) Pub. Date: Feb. 21, 2013

(54) Combination Lamp and Wireless Network Access System

(71) Applicant: G. Albert Hreish, Riverside, CA (US)

(72) Inventor: G. Albert Hreish, Riverside, CA (US)

(21) Appl. No.: 13/212,118

(22) Filed: Aug. 17, 2011

(51) Int. Cl. F21V 33/00

(52) U.S. Cl. 362/253

(57) ABSTRACT

A Combination Lamp and Wireless Network Access System, and a related Method for creating a Local Mesh Network. The device and method includes a combination lighting lamp and mesh network node. The combination lamp/node assembly is available both as original equipment, and as a retrofit kit for legacy lamps. The lamp portion of the combination lamp/node provides area lighting through a lens located in the housing within which the combination lamp/node is housed. The node portion of the assembly provides sophisticated mesh network functionality such that the placement of a series of devices of the present invention should provide a high quality, wireless “mesh” computer network. The lamp/node assembly may optionally provide local security/surveillance functionality, including cameras and sensors in order to enable typical security system functionality. The mesh network created by interconnection of a series of the lamp/node assemblies includes the ability to repair itself in the event of damage to one or more networked lamp/node assemblies, as well as the ability to constantly seek to optimize electronic traffic through the local mesh network. The lamp/node assemblies may further include Infrared communications capabilities to facilitate mesh communications between nodes in the mesh by either WiFi or Infrared means.

### BACKGROUND OF THE INVENTION

1. Field of the Invention

This invention relates generally to computer networking systems and, more specifically, to a Combination Lamp and Wireless Network Access System.

2. Description of Related Art

Wireless networking access points, or “hotspots” have become more and more prevalent in our computerized society. It is common for retail store establishments, hotels, airports and even fast food restaurants to offer hotspots to their patrons, either for free or for a daily fee. As personal computing (apparently inevitably) transitions from the current state of pc-centric computing to “cloud” computing, the desire for connection to the world wide web will become a mandatory requirement. Consequently, the need for WiFi hotspots will transition from a luxury to a necessity, because all software and data will only be accessible (in the “cloud”) through the world wide web. It is believed this need can only be truly served by using non-traditional resources for WiFi hotspots.

While a number of other approaches have been attempted, including municipally-sponsored, city-wide systems of hotspots, none have sought to make such installations simply, through utilization of existing infrastructure, devices and systems that are found in virtually all populated areas in all industrialized countries. One such resource is the street lamp.

Street lamps (including lights for lighting parking garages, parking lots, warehouses, and the like) have a variety of traits that make them desirable for utilization as WiFi hotspots: (1) they are ubiquitous—they are found on virtually every street, parking lot, parking garage, and outside every commercial building in the world; (2) due to their sheer numbers, many are found within line of sight distance from one another, making it simple to create overlapping reception areas; (3) they are weatherproof and durable, since they are designed to last for decades with little or no maintenance; and (4) they already have electrical power available (for the purpose of lamp operation). Despite these seemingly apparent strengths, to date, we are unaware of any device or system that is capable of transforming a conventional streetlamp into a WiFi hotspot.

### SUMMARY OF THE INVENTION

In light of the aforementioned problems associated with the prior devices and systems, it is an object of the present invention to provide a Combination Lamp and Wireless Network Access System, and a related Method for creating a Local Mesh Network. The device should be a combination lighting lamp and mesh network node. The combination lamp/node assembly should be available both as original equipment, and as a retrofit kit for legacy lamps. The lamp portion of the combination lamp/node should provide area lighting through a lens located in the housing within which the combination lamp/node is housed. The node portion of the assembly should provide sophisticated mesh network functionality such that the placement of a series of devices of the present invention should provide a high quality, wireless “mesh” computer network. The lamp/node assembly should optionally provide local security/surveillance functionality, including cameras and sensors in order to enable typical security system functionality. The mesh network created by interconnection of a series of the lamp/node assemblies should include the ability to repair itself in the event of damage to one or more networked lamp/node assemblies, as well as the ability to constantly seek to optimize electronic traffic through the local mesh network. The lamp/node assemblies may further include Infrared communications capabilities to facilitate mesh communications between nodes in the mesh by either WiFi or Infrared means.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 depicts an example of the world wide web at a local scale;

FIG. 2 depicts an example of a local mesh network of the system of FIG. 1;

FIG. 3 is a block diagram of a preferred embodiment of a node of the local mesh network system of FIGS. 1 and 2;

FIG. 4 is a perspective view of a streetlamp embodiment of the node of FIGS. 1-3;

FIG. 5 is a conceptual diagram of a local mesh network of FIGS. 2 and 3; and

FIG. 6 is a functional diagram of the node control system of the node of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Combination Lamp and Wireless Network Access System.

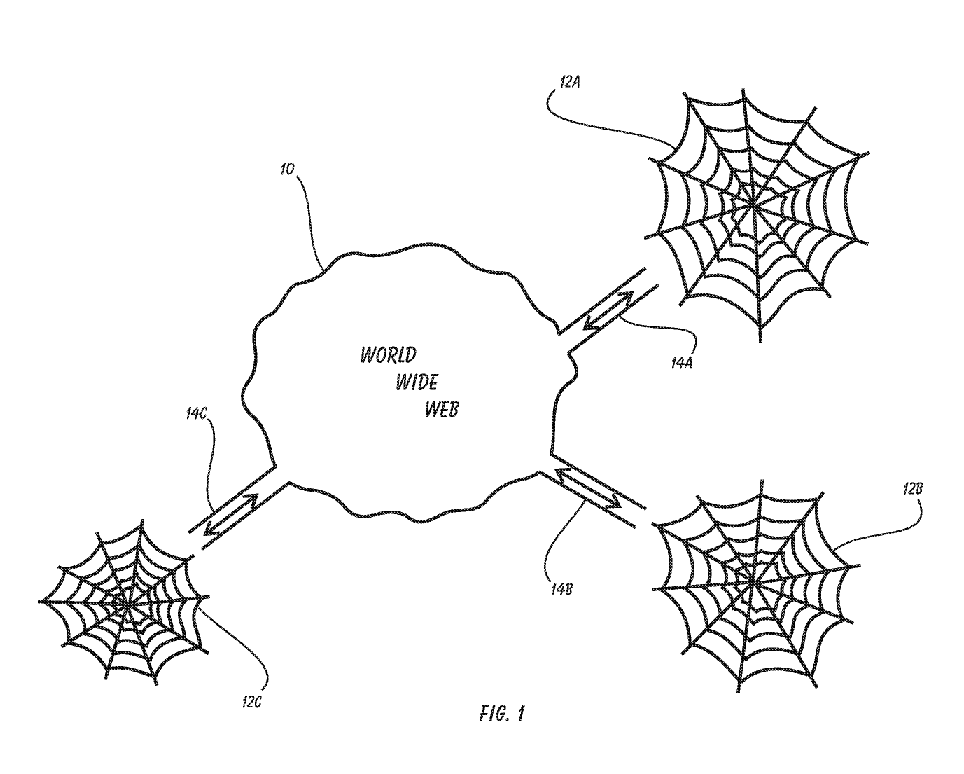

The present invention can best be understood by initial consideration of FIG. 1. FIG. 1 depicts an example of the world wide web at a local scale for the purpose of providing background for the present invention. The device and system of the present invention is intended to provide localized “mesh” networks for the purpose of creating local access to the world wide web for local computer users. As will be discussed in further detail below, these “mesh” networks have functionality and value beyond that provided by a standard local area network.

In the depicted example, there are a plurality of local mesh networks that are each independently in communication with the world wide web 10 via communications conduits (generically 14). These local mesh networks (generically 12) may or may not have any relationship with one another beyond that they have the same internal architecture and operational rules. While they may be in communication with one another, it would only be via the world wide web, and not through direct, independent interconnections. As shown, the first local mesh network 12A is in communications contact with the world wide web 10 via first communications conduit 14A. Second local mesh network 12B is in communications with the world wide web 10 via second communications conduit 14B, and third local mesh network 12C is in communications with the world wide web 10 via third communication conduit 14C.

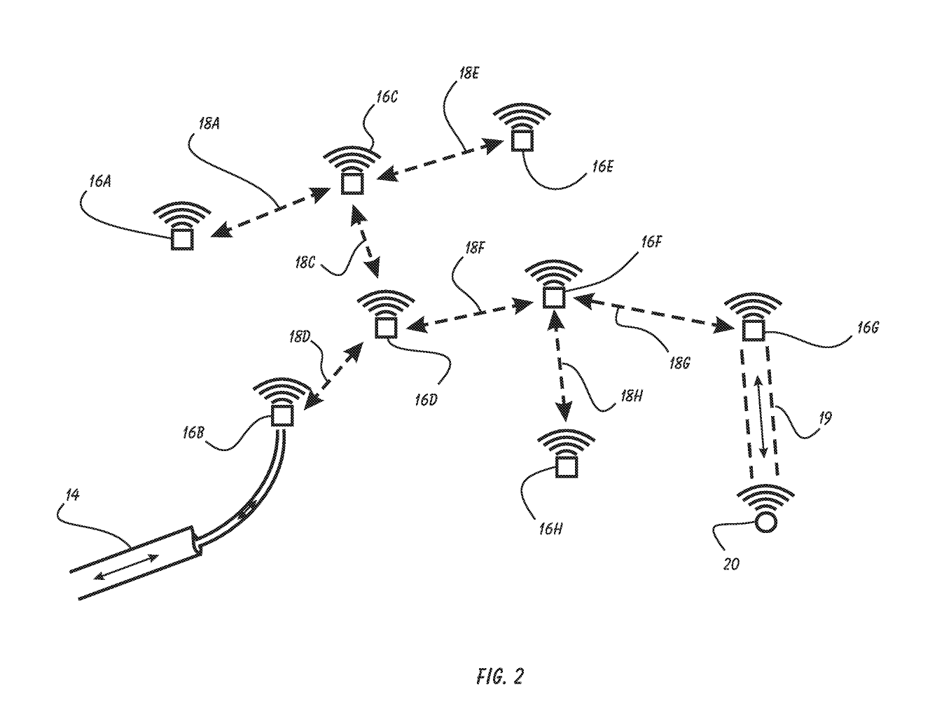

Each communications conduit (generically 14) is any conventional communications connection that permits access to and from the world wide web 10. In that it is the expectation that these conduits 14 will be transporting data for any user connecting to the associated local mesh network (generically 12), it would by typical that these conduits (generically 14) will be capable of handling multi-user simultaneous data needs. Generally, this would exclude wireless options of interconnection, however, for smaller local mesh networks (generically 12) having lower data transfer demands, wireless connections might be feasible. If we now turn to FIG. 2, we can continue to study the details of the system of the present invention.

FIG. 2 depicts an example of a local mesh network 12 of the system of FIG. 1. Each local mesh network 12 is comprised of a series of nodes (generically 16) that communicate with one another, typically wirelessly, in order to share one or more connections to the world wide web. In the depicted example, there is a single communications conduit 14 between the local mesh network 12 and the world wide web, but they system is designed to handle (i.e. through a sort of load-sharing) multiple available conduits 14 connecting to one or more nodes (generically 16) within the mesh 12.

In this example, node 16B is the only node having direct access to the world wide web. This node 16B is connected to node 16D by local mesh communications link 18D. Node 16D is connected to node 16C by link 18C and to node 16F by link 18F. Node 16C is connected to node 16A by link 18A and to node 16E by link 18E. Node 16F is connected to node 16H by link 18H and to node 16G by link 18G. Generically, each of these elements, being identical, can be called node 16 and local mesh communications link 18.

The technical and operational details regarding the nodes 16 will be discussed below in connection with subsequent drawing figures. The links 18 are communications links between adjacent (from a communications standpoint) nodes 16. Generally, these links would be wireless, such as by Radio Frequency communications (e.g. WiFi) or infrared (Ir), or some combination of both. These links 18 allow each individual node 16 to communicate with other nodes 16 within the mesh network 12. The links would not generally be long-distance, and would typically be line-of-sight.

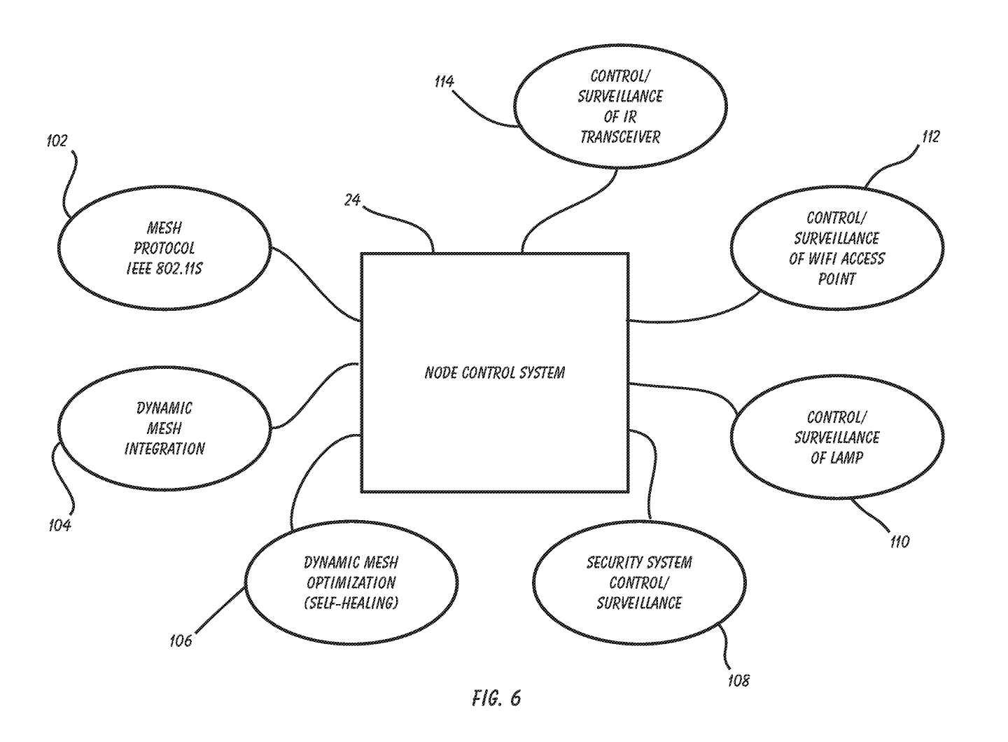

While defined links 18 are depicted here between individual nodes 16, this is not necessarily the case. Each node 16 could have as many links 18 as are there are other nodes 16 within linking distance. In fact, substantial utility is created by having numerous interconnecting links to more than one adjacent node 16. As will be discussed more fully below in connection with FIG. 6, the mesh network 12 will be more robust and flexible because of each node's 16 ability to automatically connect to as many nodes 16 as it has the ability to connect with, depending on proximity and wireless signal strength.

The purpose of interconnecting all of the nodes 16 by links 18 is to share one or more communications conduits 14 with each and every interconnected node 16. The links 18 not only allow the nodes 16 to communicate with one another for activities related to maintaining the mesh, but also to transmit data to and from the communications conduit 14.

A local mesh client 20, such as a personal computer or other world wide web-enabled device will “see” each node 16 as a wireless hotspot. Connection by WiFi to any of the nodes 16 will create a client communications conduit 19 with that node (in this case 16G). As depicted in this example, communications to and from client 20 will travel through the communications conduit 19 to node 16G, through link 18G to node 16F, through link 18F to node 16D, through link 18D to node 16B, and then to the world wide web by communications conduit 14. If link 18 quality changes between any of the nodes 16, or if the client 20 relocates physically, the communications routing through the mesh 12 will also change in order to provide the strongest and most reliable data communications quality to the client 20. It should also be understood that the communications conduit 14 shown here may not be actually hardwired to any of the nodes 16. The conduit 14 could also be of the wireless variety. For example, any one of the nodes 16 could be connected to a wireless access point that is in close physical proximity to that particular node 16. Once that one node 16 is connected wirelessly to the external wireless access point, the reach of that wireless access point is effectively extended to include all of the nodes 16 within the local mesh network 12. In such a case, the communications conduit 14 would not be the wire structure depicted here, but rather would be an RF connection with the (non-depicted) wireless access point.

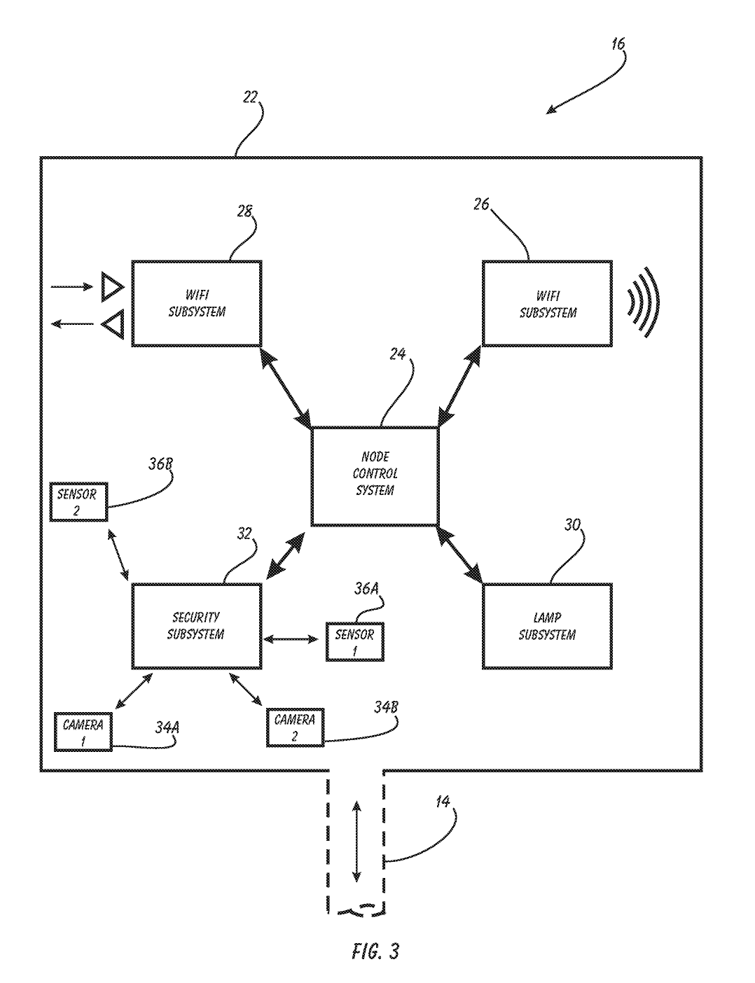

In yet another version, the communications conduit 14 is actually combined with the electrical power supply to the node 16. Known as powerline networking, this is an architecture that allows the standard electrical power cables to double as networking communications conduit. Typically these systems include a router device interconnecting a external network portal to a particular electrical power system; in order to add a node 16 to this powerline networking system, the communications conduit 14 would be network cabling connecting a node 16 of the local mesh 12 to a node of the powerline networking system (that is in communications with the powerline router device over the electrical power line). As will be more relevant with regard to the discussion related to subsequent drawing figures, the use of the electrical power cables for network communications eliminates the need for a separate cable system for the communications conduit 14. FIG. 3 provides additional detail regarding the nodes 16 of this invention.

FIG. 3 is a block diagram of a preferred embodiment of a node 16 of the local mesh network system (see e.g. FIG. 2) of FIGS. 1 and 2. The node 16 can be an original equipment device (i.e. designed from the ground up to operate as a node 16 of the present description), or it can be configured as an after-market replacement module that can be installed or retrofitted into an existing fixture of piece of equipment as will be discussed below.

In its preferred form, each node 16 will be contained within a single housing 22. Each node will include a node control system 24. The node control system 24 is the hardware, firmware, software module that provides the operational features that are discussed herein. It controls each of the other systems making up the node 16 (most, if not all of which are contained within the housing 22). Each of the following subsystems are not necessarily included within every node 16, and therefore those items presented here may or may not be optional.

The WiFi subsystem 26 provides the necessary elements to allow the node 16 to communicate with other nodes 16, or with local mesh clients (see FIG. 2). The mesh communications protocols themselves may be contained within the either the WiFi subsystem 26 or the node control system 24, as desired. These operational features are more fully discussed below in connection with FIG. 6. The Ir (infrared) subsystem 28 provides the node 16 with a short-range, secure method of communications. This communication could be useful for inter-node communications either for client data handling, or more likely for control and operation of the mesh network itself.

The security subsystem 32 can provide additional security and data recording/transmission features. The subsystem 32 may be in communication with one or more cameras (e.g. 34A-34C) and/or sensors (e.g. 36A-36C) that are located either within or outside of the housing 22. Alternatively, the cameras and/or sensors may use either infrared or RF technology to communicate with the security subsystem 32 from either inside or outside of the housing 22.

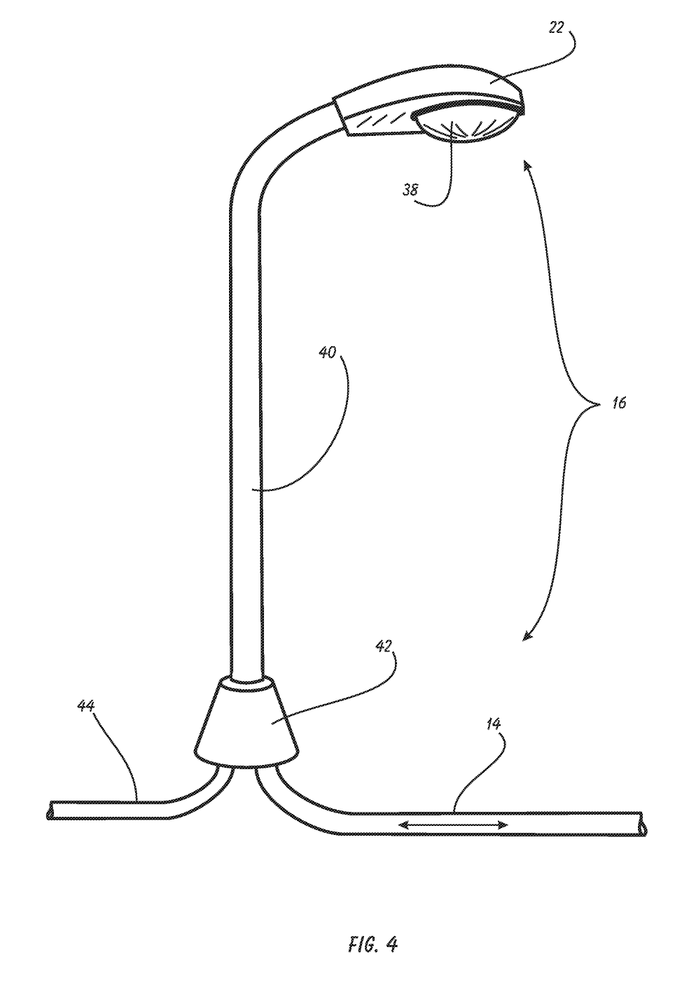

Lamp subsystem 30 is related to the control and operation of, and communication with an area lighting lamp module, as will be better understood by review of FIG. 4.

FIG. 4 is a perspective view of a streetlamp embodiment of the node 16 of FIGS. 1-3. The version depicted here is only one of several types and forms of lamp structure within which the device of the present invention could be contained. Furthermore, it must be understood that the elements of the node 16 could be contained solely within the lamp housing 22, or in other designs (such as the OEM version) the functional elements of the node 16 as described in FIG. 3 could be dispersed throughout the entire structure of the combination lamp/node 17 of the present invention. In certain cases, the elements of the node 16 will be contained within a retrofit subassembly for a conventional lamp (such as a street lamp). This subassembly will be described in detail in one or more separate patent disclosures. Such a retrofit lamp/node subassembly would be designed to take the place of the lamp and ballast portions (and related circuits) of the street lamp. The retrofit lamp/node subassembly would include an improved lamp (e.g. an LED lamp), while also adding the node structure and functionality discussed herein. That retrofit lamp/node subassembly would preferably be easily installed in place of the conventional lamp and ballast portions without special tools or additional modification to the lamp structure. The disclosure herein is intended to apply to each of these embodiments, with the only potential difference being the location within the combination lamp/node 17 that the individual elements will be actually positioned.

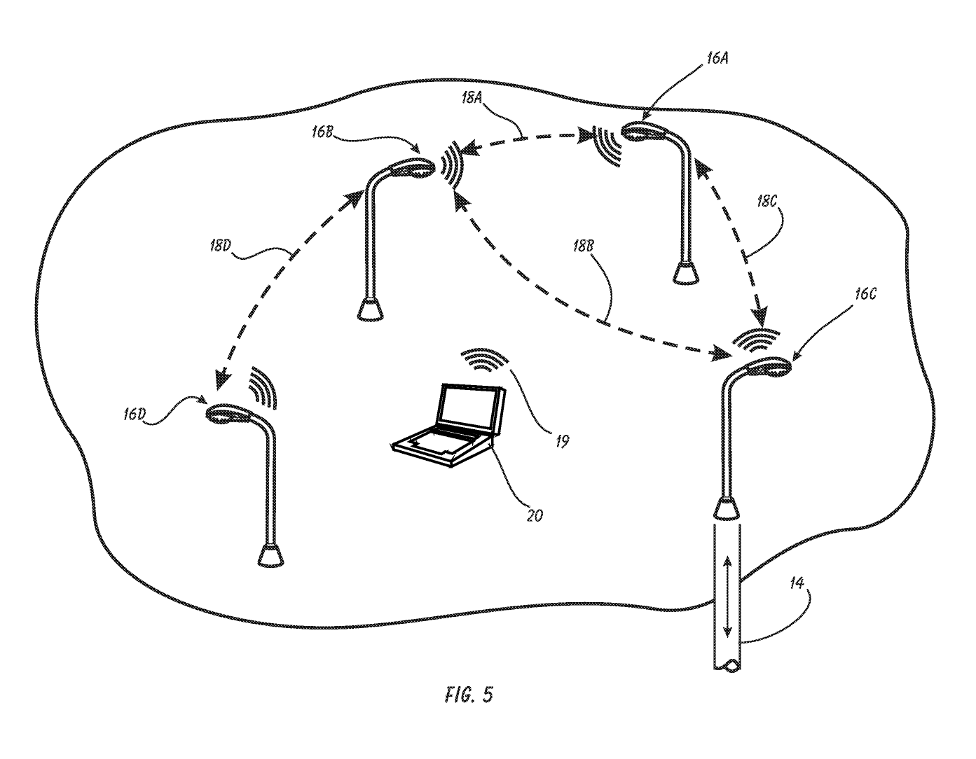

In this version of the node 16 or combination lamp/node 17, the housing 22 sits atop a pole 40. In other embodiments, the housing 22 could be attached to an wall or other separate structure. The pole 40 is supported by a base 42 where it attaches to the ground. The lamp/node 17 receives electrical power just as would a conventional street lamp, that is through an electrical power conduit 44. Communications conduit 14 is provided to the lamp/node 17 with by the hardwired cable as shown, or by the other approaches discussed previously (i.e. external WiFi access point or powerline networking). The clear lens 38 is provided within the housing in order to allow light emitted from the lamp subsystem (see FIG. 3) to provide illumination therethrough, while providing security and weather protection to the internal components of the node 16. FIG. 5 shows this device/assembly 16/17 in operation.

FIG. 5 is a conceptual diagram of a local mesh network 12 of FIGS. 2 and 3. Each combination lamp/node is within wireless range (either via RF or infrared) of at least one other lamp/node. As should be apparent, street lamps, parking lot lamps and other outdoor security lamps are generally large clusters of lamps that are in close proximity to one another and to lamps making up adjacent clusters of lamps. Consequently, it is expected that a using street lamps and the like as wireless access points will provide large blankets of wireless networking coverage without the need for specialized installations of equipment.

Here, node 16D is in wireless contact via link 18D with node 16B; node 16B has links 18A and 18B with nodes 16A and 16C, respectively. Node 16A further has link 18C with node 16C. It is node 16C that has the connection for the local mesh network 12 with the communications conduit 14. Finally, we will turn to FIG. 6 to examine some functional particulars for the present system.

FIG. 6 is a functional diagram of the node control system 24 of the node of the present invention. The system 24 is expected to operate in accordance with Draft Mesh Network Protocol IEEE 82.11s in its handling of communications with other nodes in the local mesh network. An operational feature of the system 24 is that of Dynamic Mesh Integration 104. Dynamic Mesh Integration means that that new nodes discovered by the existing mesh will be integrated automatically by the mesh network, thereby expanding the physical coverage of the existing local mesh network.

Dynamic mesh optimization 106 is another operational feature of the instant system 24. Each node will repeatedly test link communications quality to detect if the existing link being used for network communications is the best available. If a better route to the communications conduit is determined to be available, then that particular node will automatically abandon its existing network communications path in favor of the improved path. The information regarding mesh or link strength could be shared between nodes either via RF communications, or alternatively by infrared or other communications method.

The security sensors and video recording functions of the node interface with (or through) and are controlled by the node control system 24. This could mean that certain security subsystems (in certain nodes) are performing different functions or have different operational settings than others. It would be expected that all of them could be individually addressed via its particular node control system for control of the security subsystem and/or to obtain alerts, alarms, and even to upload recorded or real-time security data.

The system 24 will allow for the control and surveillance of the lighting lamp subsystem 110. Presumably, this allows for the scheduled turning on and off of the lamp. If the lamp has the capability for other operational and/or diagnostic modes, then these features would also be controlled via interface with or through the node control system 24.

The WiFi access point control, supervision and operational surveillance 112 shall be conducted with or through the node control system 24 within the node circuitry. Subscriber logging, security rules, logon encryption and other normal aspects related to the operational control of most wireless access points will be controlled or actually operated by the node control system 24. Of course, in most cases this will involve the imposition of the same rules, etc. for all nodes within a particular local mesh network, although selective control and rule-making may be used as well.

Similarly, the control and operational surveillance of the infrared transceiver subsystem 114 will be either handled by or in cooperation with the node control system 24.

As with the WiFi subsystem, the rules for security and connection availability, as well as encryption, etc. will be a part of this functionality 114.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A combination lamp and wireless network access system, comprising:
a housing;
a lamp contained within said housing; and
a node comprising a wireless network access subsystem within said housing.

2. The combination of claim 1, wherein said node further comprises an infrared communications subsystem within said housing.

3. The combination of claim 2, wherein said node further comprises a security subsystem contained within said housing.

4. The combination of claim 3, wherein said housing further comprises a lens positioned relative to said lamp so that light emitted from said lamp shines through said lens.

5. The combination of claim 4, further comprising a wide area computer network communications conduit in connection with said node.

6. The combination of claim 5, wherein said wireless network access system comprises two or more said combinations, wherein at least one said node is in wireless communication with another said node in said system.

7. The combination of claim 6, wherein said security subsystem further comprises at least one sensor and at least one video capture device for recording video responsive to said sensor, at least one said sensor and at least one said video capture device located within said housing.

8. The combination of claim 7, wherein said housing comprises a base, a pole extending from said base, and a node housing extending from said pole.

9. A local mesh computer network, comprising:
a first combination lamp/node assembly;
a second said combination lamp/node assembly in wireless communication with said first lamp/node assembly via a local mesh communications link; and
wherein each said lamp/node assembly comprises a housing within which a wireless networking subsystem and a lamp subsystem are located.

10. The network of claim 10, wherein each said wireless networking subsystem in communication with said local mesh network comprises dynamic mesh optimization functionality, said dynamic mesh optimization functionality comprising the ability for each said wireless networking subsystem to detect and monitor all said local mesh communications links between lamp/node assemblies in said local mesh network in order to choose a route that optimizes communications over said link to a wide area network communications conduit in communication with said local mesh network.

11. The network of claim 10, wherein each said lamp/node assembly further comprises an infrared communications subsystem within said housing.

12. The network of claim 11, wherein each said lamp/node assembly further comprises a security subsystem contained within said housing.

13. The network of claim 12, wherein said housing further comprises a lens positioned relative to a lamp electrically associated with each said lamp/node assembly so that light emitted from said lamp shines through said lens.

14. The network of claim 13, further comprising a wide area computer network communications conduit in direct connection with at least one said lamp/node assembly.

15. The network of claim 14, wherein each said security subsystem further comprises at least one sensor and at least one video capture device for recording video responsive to said sensor, at least one said sensor and at least one said video capture device located within said housings.

16. The network of claim 15, wherein at least one said housing comprises a base, a pole extending from said base, and a node housing extending from said pole.

17. A method for creating a local mesh computer network, comprising the steps of:
providing a first combination lamp/node assembly; and
providing a second said combination lamp/node assembly in wireless communication with said first lamp/node assembly via a local mesh communications link, wherein each said lamp/node assembly of said providing steps comprise a housing within which a wireless networking subsystem and a lamp subsystem are located.

18. The method of claim 17, wherein each said wireless networking subsystem in communication with said local mesh network of said providing steps comprises dynamic mesh optimization functionality, said dynamic mesh optimization functionality comprising the ability for each said wireless networking subsystem to detect and monitor all said local mesh communications links between lamp/node assemblies in said local mesh network in order to choose a route that optimizes communications over said link to a wide area network communications conduit in communication with said local mesh network.

19. The method of claim 18, wherein each said housing of said providing steps further comprises a lens positioned relative to a lamp electrically associated with each said lamp/node assembly so that light emitted from said lamp shines through said lens.

20. The method of claim 19, wherein said providing steps comprise the following initial steps:
removing a lamp assembly from two or more existing lamp housings;
replacing each said removed lamp assembly with one said lamp/node assembly; and
providing a direct interconnection between at least one said lamp/node assembly and a wide area computer network communications conduit.
